(19) United States
(12) Patent Application Publication
(10) Pub. No.: US 2018/0288466 A1
(43) Pub. Date: Oct. 4, 2018

(54) METHODS AND SYSTEMS FOR DISCOVERY AND/OR SYNCHRONIZATION

(71) Applicant: Comcast Cable Communications, LLC, Philadelphia, PA (US)

(72) Inventors: Edward David Monnerat, Philadelphia, PA (US); Ross Gilson, Philadelphia, PA (US)

(21) Appl. No.: 15/476,019

(22) Filed: Mar. 31, 2017

(51) Int. Cl. H04N 21/43; H04N 21/45; H04N 21/482; H04N 21/426; H04N 21/41

(52) U.S. Cl. CPC H04N 21/4302; H04N 21/4516; H04N 21/6125; H04N 21/42684; H04N 21/4104; H04N 21/482

(57) ABSTRACT

Methods and systems for discovering and/or synchronizing a plurality of devices are described. Status information associated with one or more devices may be received. A registry of associated devices may be generated based on at least the status information. A user interface may be rendered based at least on the registry of associated devices. The user interface may indicate content outputted by the one or more devices.

### BACKGROUND

Multiple devices may be configured to synchronize content between each other. However, such devices may fall out of alignment due to hardware, software, or network performance issues. Additionally or alternatively, devices may be under different amounts of resource loads or constraints, which may cause delays in processing, thereby impacting synchronization and continuity between devices. These and other shortcomings are addressed by the present disclosure.

### SUMMARY

Systems and methods are described for the discovery and/or synchronization of one or more devices. Playback information associated with an actual and/or predictive playback position within a content item may be shared between devices. As an example, each device associated with a user may transmit playback information on a periodic basis. Such association with a user may comprise association with a user account, a user or premises network, user credentials, and the like. One or more devices associated with the user may receive the transmitted playback information and may maintain a registry of devices and content being presented via such devices. The registry may facilitate the synchronization of content between devices. The registry may facilitate navigation between content provided via one or more devices.

### BRIEF DESCRIPTION OF THE DRAWINGS

The accompanying drawings, which are incorporated in and constitute a part of this specification, illustrate aspects and together with the description, serve to explain the principles of the methods and systems:

FIG. 1 is a block diagram of an example network;

FIG. 2 is a block diagram of an example system architecture;

FIG. 3 is a block diagram of an example system architecture;

FIG. 4 is a flow chart of an example method;

FIG. 5 is a flow chart of an example method;

FIG. 6 is a flow chart of an example method; and

FIG. 7 is a block diagram of an example computing system.

### DETAILED DESCRIPTION

Content providers (e.g., service providers, digital rights holders, content distributors, etc.) may transmit various content items to a plurality of devices. Such devices may be associated with one or more user accounts to facilitate the access to the content items by users associated with the user accounts. Such devices may receive and present (e.g., render) different content items at the same time. For example, a first device disposed in a living room of a premises may output (e.g., present) a first content item, while a second device disposed in a bedroom of the premises may present a second content item. As a further example, a first device associated with a premises network may present a first content item, while a second device disposed external to the premises network may present a second content item. Other configurations and devices within a premises or external to a premises may be used.

In any number of device configurations, it may be desirable for a user to know what content is being presented via one or more devices at any given time. For example, systems and methods may facilitate the continuous or periodic discovery of content being presented via one or more devices. A user interface may be presented to facilitate navigation between content displayed on various devices. As such, a user may use the user interface to select presentation of content from the content being presented on the other devices. Additionally or alternatively, content between two or more devices may be synchronized, for example using predictive playback information discovered between the devices.

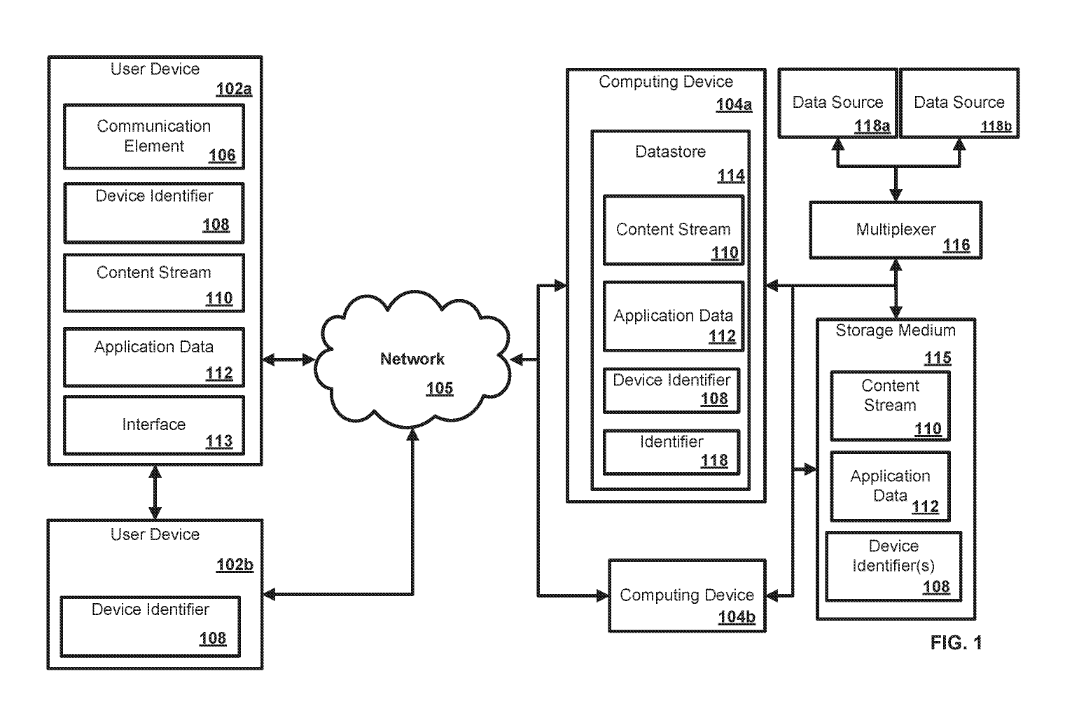

FIG. 1 illustrates various aspects of an exemplary environment in which methods and systems may operate. Systems and methods may be associated with a user device, for example. Those skilled in the art will appreciate that present methods may be used in various types of networks and systems that employ both digital and analog equipment. One skilled in the art will appreciate that provided herein is a functional description and that the respective functions may be performed by software, hardware, or a combination of software and hardware.

The network and system may comprise one or more user devices 102a, 102b in communication with one or more computing devices 104a, 104b such as a server, for example. The computing devices 104a, 104b may be disposed locally or remotely relative to the user devices 102a, 102b. As an example, the user devices 102a, 102b and the computing devices 104a, 104b may be in communication via a private and/or public network 105 such as the Internet. Other forms of communications may be used such as wired and wireless telecommunication channels, for example.

The user devices 102a, 102b may be an electronic device such as a computer, a smartphone, a laptop, a tablet, a set top box, an over-the-top device, a display device, a network-enabled device, or other device capable of communicating with the computing devices 104a, 104b.

The user devices 102a, 102b may comprise a communication element 106 for providing an interface to a user to interact with the user devices 102a, 102b and/or the computing devices 104a, 104b. The communication element 106 may be any interface for presenting information to the user and receiving a user feedback such as an application client or a web browser (e.g., Internet Explorer, Mozilla Firefox, Google Chrome, Safari, or the like). Other software, hardware, and/or interfaces may be used to provide communication between the user and one or more of the user devices 102a, 102b and the computing devices 104a, 104b. As an example, the communication element 106 may request or query various files from a local source and/or a remote source. As a further example, the communication element 106 may transmit data to a local or remote device such as the computing devices 104a, 104b.

One or more of the user devices 102a, 102b may be associated with a user identifier or device identifier 108. As an example, the device identifier 108 may be any identifier, token, character, string, or the like, for differentiating one user or user device (e.g., user devices 102a, 102b ) from another user or user device. The device identifier 108 may identify a user or user device as belonging to a particular class of users or user devices. As a further example, the device identifier 108 may comprise information relating to the user device such as a manufacturer, a model or type of device, a service provider associated with the user devices 102a, 102b, a state of the user devices 102a, 102b, a locator, and/or a label or classifier. Other information may be represented by the device identifier 108.

The device identifier 108 may be persistent or may be temporary or periodic. As an example, the device identifier 108 may be assigned to each device associated with a network such as a local area network or premises network. As another example, the device identifier 108 may be one of a group of assignable IP addresses. The device identifier 108 may be used in communication via the communication element 106 of a respective user device 102a, 102b. As an example, where the communication device 106 comprises a web browser, the web browser may embed the device identifier 108 in communications (e.g., requests) transmitted over the network. As such, the device identifier 108 may be a detectable by a receiving web server and the web server may extract the device identifier 108 from the communications.

One or more of the user devices 102a, 102b may be associated with a user. The association may be facilitated by a user account or a premises network associated with a user premises. As an example, the device identifier 108 associated with one or more of the user devices 102a, 102b may be associated (e.g., joined) with a user account. As another example, for user devices 102a, 102b accessing a premises network, the device identifier 108 associated with one or more of the user devices 102a, 102b may be discovered (e.g., auto-discovered) by a network device. For devices (such as mobile devices) external to the premises network, the association to a user may be facilitated via a user sign-in processes, for example, by receiving user credentials. Other mechanisms for associating one or more user devices 102a, 102b with a user may be used.

The user devices 102a, 102b may be configured to transmit and/or receive various signals such as a data signals transmitted via the Internet Protocol (IP) or other protocols. As an example, the signals may be transmitted and/or received between the user devices 102a, 102b and the computing devices 104a, 104b. As an example, the user devices 102a, 102b may transmit requests for content to a RTSP, MPEG, SDP, or other streaming server such as the computing device 104a. As another example, the user devices 102a, 102b may be configured to receive a content stream 110 such as a transport stream (e.g., in response to the request for content). The content stream 110 may be an MPEG transport stream such as a multi-program transport stream or a single program transport stream. The content stream 110 may be processed (e.g., decoded) by the user devices 102a, 102b to provide playback of the content comprised in the content stream 110, for example, via an interface 113 such as a display. As an example, the playback of the content may comprise video playback.

The user devices 102a, 102b may be configured to receive application data 112 such as binary application data. The application data 112 may comprise at least a portion of data that, when processed, may form an executable application. Such an application may be executed via the user devices 102a, 102b. As an example, the application may relate to the content received by the user devices 102a, 102b. However, the application may be independent of the content. As an example, the application data 112 required to compile the complete application may be divided into portions or data chunks. As another example, the application data 112 or portion thereof may be received by the user devices 102a, 102b via the transport stream used to deliver the content stream 110. As a further example, the application data 112 may be delivered to the user devices 102a, 102b via the MPEG Adaptation field, other data tables, or by identifying when null packets exist and replacing null packets with application data as payload data packets.

As an illustrative example, as the user devices 102a, 102b provides playback of content from the transport stream, the application data 112 may be downloaded. A threshold portion of the application data 112 may be received by the user devices 102a, 102b and the user devices 102a, 102b may process the received application data 112 to execute an application, for example via the interface 113. Applications could be downloaded that are related to a broadcast network, program topic, user profile, user demographic, service level, advertiser, geographic location, or usage pattern. An example of an application may be or comprise a cooking application related to cooking program content. Another example may be or comprise an educational children's application related to a children's television network. Another application example would be a sports application related to a sports programming usage pattern. The application may be persistently stored to the user devices 102a, 102b and/or may be removed (e.g., based on resource availability of the user devices 102a, 102b ). The application may communicate with a server such as an FTP, HTTP, or Restful server (e.g., computing device 104b ) for providing a user experience to a user of the user devices 102a, 102b.

Information may be transmitted and received (e.g., shared) between various devices such as the user devices 102a, 102b. As an example, one or more of the user devices 102a, 102b may periodically broadcast status information. As a further example, one or more devices may subscribe to another device to receive status information transmissions and updates. The status information may include a device identifier (e.g., device identifier 108), a content identifier, and a time code associated with the content identifier. The time code may indicate an actual or predictive position within a content item associated with the content item. The user devices 102a, 102b may receive status information and may use the status information to access additional information via the computing device(s) 104a, 104b or other device (e.g., service provider device). The status information may include a portion of the content being displayed such as a screen shot so that the recipient devices may present a graphical representation of the content being presented on various devices.

Status information may be transmitted via an update packet. To prevent overloading the network with unnecessary packets, the update packet itself may only contain the minimum amount of data necessary to identify a device and a piece of content, such as for example, a media access control address (MAC address), a program/content asset identifier, and time code (playback position along content). With the packet of status information transmitted to another device, recipient devices may access a network/back office catalog to retrieve any necessary details about a program in order to render it to the screen and tune to it. Additionally or alternatively, devices may have access to the account device list and may look up the devices with the provided device identifier (MAC) to retrieve the name that a user has associated with a device (“Dave's Phone”, “Office DVR”). Because these devices have access to the back office data, the system may not need to overload the update packet with data that can be found elsewhere. However, any information may be included in the status information and related packets. If there is available space in the update packet, additional metadata may be included to minimize the need for a lookup for “dumb” devices without connectivity. For example, a screen shot may be included in the payload so that the other devices on the network have a graphic that they can display for an updated presentation instead of simply showing default program or episode art.

The communication of status information between various devices may facilitate the switching between content being presented via the various devices. As an example, if a user wants to tune a living room device to the program currently being watched on an office device, the user may request a “last known” position from the office device. In particular, the living room device may access a registry of devices including the status information received from the office device. This status information may be used to tune the living room device to the most up-to-date position in content being presented via the office device. As another example, the living room device may make an in-time request to the office device to update the status information associated with the office device. A response to the request may include up-to-date content information including a content identifier associated with a content item and a playback position in the content item. The response may include any current action being taking on the office device (e.g., playback is at position 1:23 and content is paused or playback is at position 1:34 and content is rewinding at 2x rewind). Other configurations may be used and other information may be shared.

One or more of the computing devices 104a, 104b may be a server for communicating with the user devices 102a, 102b. As an example, the computing devices 104a, 104b may communicate with the user devices 102a, 102b for providing services such as streaming services and/or application-related services. The computing devices 104a, 104b may allow the user devices 102a, 102b to interact with remote resources such as data, devices, and files. As an example, the computing devices 104a, 104b may be configured as central location (e.g., a headend, or processing facility), which may receive content (e.g., data, input programming) from multiple sources. The computing devices 104a, 104b may combine content from various sources (e.g., data sources 118a, 118b) and may distribute the content to user (e.g., subscriber) locations via a distribution system.

One or more of the computing devices 104a, 104b may manage the communication between the user devices 102a, 102b and a datastore 114 for sending and receiving data therebetween. As an example, the datastore 114 may store a plurality of data sets (e.g., indexes, content items, data fragments, location identifiers, relational tables, user device identifiers (e.g., identifier 108) or records, network device identifiers (e.g., identifier 118), or other information. As a further example, the user devices 102a, 102b may request and/or receive (e.g., retrieve) a file from the datastore 114 such as a manifest of one or more location identifiers associated with one or more content items. The datastore 114 may store information for delivery to the user devices 102a, 102b such as the content stream 110 and/or the application data 112. A storage medium 115 physically and/or logically remote from one or more of the computing devices 104a, 104b may be configured to store information such as the content stream 110 and/or the application data 112.

Data from one or more sources (e.g., data sources 118a, 118b) may be multiplexed via multiplexer 116 to generate a transport stream. The multiplexer 116 may comprise an encoder or transcoder for encoding the source data into the transport stream such as a MPEG transport stream. The multiplexer 116 may be any device, system, apparatus, or the like to combine, encode, and/or transcode the source data into a transport stream. Although a multiplexer is illustrated, it is understood that data from one or more sources may be transmitted in various forms and under various specification and protocols, with or without multiplexing.

The multiplexer 116 may receive video content from the data source 118a and may receive application data from the data source 118b and may combine the application data with the video content into a single transport stream for delivery to the user devices 102a, 102b. As an example, one or more of the data sources 118a, 118b may comprise a content provider for providing one or more of audio content, video content, data, news feeds, sports programming, advertisements, and the like. As another example, one or more of the data sources 118a, 118b may comprise a network data feed transmitting the data stream to users such as subscribers or clients. As a further example, one or more of the data sources 118a, 118b an application server store, a source for binary applications, and/or a firmware source.

As an illustrative example, a user may interact with the user devices 102a, 102b to request first content such as a video program. While watching the video program via the user devices 102a, 102b, in the background the user devices 102a, 102b is receiving binary data packets via the transport stream providing the video program. Once the complete data set comprising the application is completely downloaded, the user devices 102a, 102b may execute the application, for example an interactive game or service. The application may be persistently stored such that the application may be used at subsequent times.

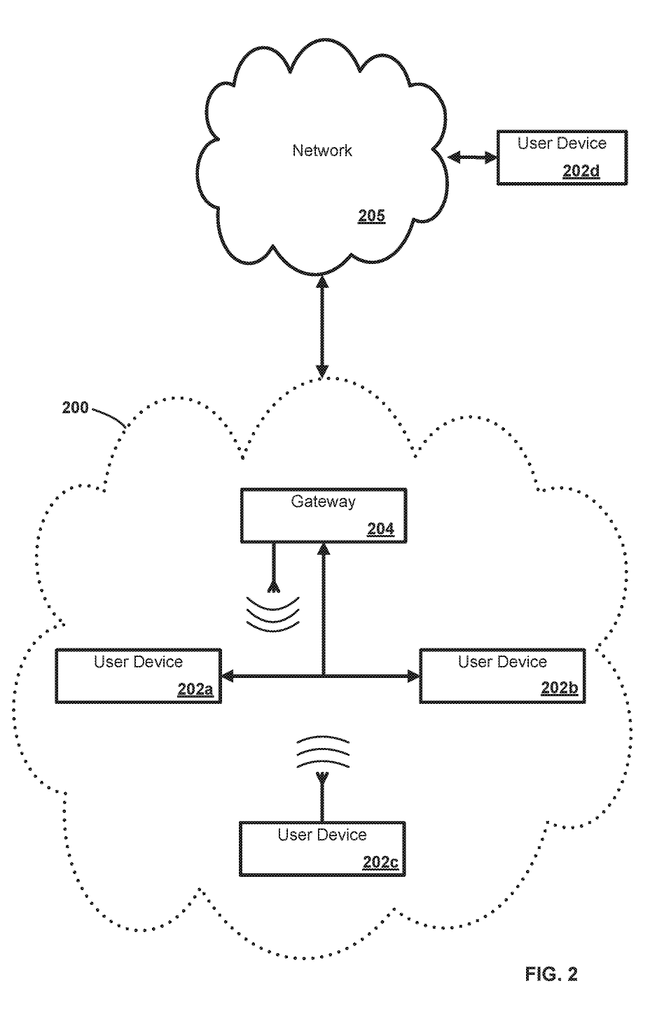

FIG. 2 illustrates various aspects of an exemplary environment in which the present methods and systems may operate. The present disclosure is relevant to systems and methods for providing services to a user device, for example. Those skilled in the art will appreciate that present methods may be used in various types of networks and systems that employ both digital and analog equipment. One skilled in the art will appreciate that provided herein is a functional description and that the respective functions may be performed by software, hardware, or a combination of software and hardware.

A premises network 200 may be in communication with a network 205. The premises network 200 may be or comprise a wired network, a wireless network, or a combination of both. The premises network 200 may be or comprise a MoCA (multimedia over coax alliance) network, a WiFi network, a local area IP network, or a combination thereof. The network 205 may be or comprise a private or public network external to the premises network 200. The network 205 may be or comprise a wide area network, a content delivery network, or a combination of both.

One or more user device 202, which may be similar to the user devices 102 (FIG. 1), may transmit and receive messages (e.g., status information) via the premises network 200. As an example, one or more of the user devices 202a, 202b may broadcast messages over the premises network 200 as a wired network, such as MoCA. As another example, a user device 202c may broadcast messages over the premises network 200 as a wireless network, such as WiFi, optical, etc. Other ones of the devices 202a, 202b, 202c may discover the broadcast messages and receive the information therein. A gateway 204 may be associated with the premises network 200 and may be configured to bridge wired and wireless networks. The gateway 204 may be configured to provide communication between the premises network 200 and the network 205. As a further example, a user device 202d may be disposed external to the premises network 200 and may transmit messages over the network 205, which may be received by the gateway 204 and provided to one or more of the user device 202a, 202b, 202c on the premises network 200.

A device such as the gateway 204 may operate as a bridge between a WiFi and MoCA (or other network) devices and pass through updates from one network to another. MoCA devices that do not have WiFi may broadcast their updates, and WiFi devices that do not have MoCA may broadcast updates over WiFi. The gateway 204 may post MoCA broadcast updates for the WiFi devices and similar may post WiFi broadcast updates for the MoCA devices. The gateway 204 may also cache the updates and re-broadcast if and when a new device joins the network, or to look for devices spanning both networks (so it can choose not to rebroadcast).

For devices that are outside of the home (e.g., user device 202d ), a user may need to associate with an account to access content from a service provider. If a user provide sign-in information (e.g., credentials) a device external to the premises network 200 may transmit status information to the gateway 204 via the network 205. As such, the gateway 204 may relay the status information to the in-home devices via the premises network 200.

One or more of the user devices 202a, 202b, 202c, 202d may be associated with a user, for example, to facilitate access to services, content, and sharing of information. The association may be facilitated by a user account or a premises network associated with a user premises. As an example, a device identifier associated with one or more of the user devices 202a, 202b, 202c, 202d may be associated (e.g., joined) with a user account. As another example, for user devices 202a, 202b, 202c accessing the premises network 200, a device identifier (e.g., MAC address) associated with one or more of the user devices 202a, 202b, 202c may be discovered (e.g., auto-discovered) by a network device such as the gateway 204. For devices (such as user device 202d ) external to the premises network 200, the association to a user may be facilitated via a user sign-in processes, for example, by receiving user credentials. Other mechanisms for associating one or more user devices 202a, 202b, 202c, 202d with a user may be used. Once associated, the one or more user devices 202a, 202b, 202c, 202d may transmit and receive status information between each other. However, association with a user is used as an example only and other unassociated devices may also transit and receive status information.

Various methods may be leveraged to provide status information associated with content currently being presented on various devices (e.g., user devices 202a, 202b, 202c, 202d ). As an example, using an in-home network, such as MoCA, each of a plurality of devices may be configured to periodically transit status information (e.g., a broadcast packet) including minimally necessary information to identify the transmitting device and the content item being presented. Other devices associated with the home network may discover the status information and may be configured to create and maintain a registry of devices including the status information.

When a device on the home network transmits updated status information, the other devices on the home network may receive the status information and may update the registry of devices. If a device has not reported in for pre-defined time period, status information associated with the device may be removes from the registry of devices or a direct interrogation/request may be made of the device (or other device or system) for updated status information. After a device stops presenting a particular content item, a message may be transmitted over the network to update other devices on the network. As such, the information associated with the registry of devices may be updated to include up-to-date status information. Additionally or alternatively each status information message may include a “time to live” or a period of time element. After the period of time expires, the status information associated with the expired message may be removed from the registry of devices. Additionally or alternatively a publish-and-subscribe model may be used. For example, devices that are currently presenting content may not transmit status information updates until another device subscribes to the transmitting device. Additionally or alternatively, subscriptions to updates may be filtered, such that only specific types of updates are received by certain devices or that certain subscription are communicated at designated frequencies or bands.

The status information (e.g., broadcast packets) may include an identifier of the transmitting device (e.g., device identifier) and an identifier of the content item being presented. The device identifier may be or comprise a MAC address or other identifier. The content identifier may be or comprise a program identifier or a virtual channel for a device presenting live content. For example, a content identifier for a digital video recorder (DVR) content may be or comprise a program ID or episode ID, which the transmitting device may access via program guide data. Since other devices associated with a user (e.g., user account) may have access to the same content channels and DVR content assets, the other devices may use the status information to look up the actual content item and to retrieve the program name, program artwork, and other data that may be used to both present the program on the guide and to, if selected, tune to the same content item.

The status information may include a time code indicating an actual or predictive playback position in the content item that is currently being presented by a device. With the time code, another device may cause playback of a content item at the same point in the content item as the device transmitting the status information.

As an example, if a device reports (e.g., transmits, broadcasts, etc.) that it is 92 minutes into a content item and the time code was transmitted 1 minutes ago (e.g., based on time metadata and/or a network clock) a receiving device may tune to the same content item identified in the status information, and in particular, to a 93 minute mark accounting for the 92 minutes in the time code and the 1 minute transmission differential. As such, the transmitting and the receiving device may be synchronized. Moreover, using the timing differential from transmission to reception doesn't require a direct interrogation of all the devices on the network and, instead, provides a passive way to collect and maintain a registry of last known content and location.

As another example, a first device may be presenting content at a position with a time code of 67 minutes (e.g., based on time metadata and/or a network clock). A receiving second device may tune to the same content item identified in the status information, and in particular, to a minute mark of 67 minutes based on the time code. However, status information may also indicate that the first device is paused. As such, the content presented via the second device may be displayed in a pause state. When the status information indicates the first device has resumed content playback, the second device may resume playback and may adjust the playback position to account for a transmission delay (e.g., based on transmission/receipt time using a network clock).

Various information may be transmitted and received (e.g., shared) between various devices such as the user devices 202a, 202b, 202c, 202d. As an example, one or more of the user devices 202a, 202b, 202c, 202d may periodically broadcast status information. As a further example, one or more user devices 202a, 202b, 202c, 202d may subscribe to another user device 202a, 202b, 202c, 202d to receive status information transmissions and updates. The status information may include a device identifier (e.g., device identifier), a content identifier, and a time code associated with the content identifier. The time code may indicate an actual or predictive position within a content item associated with the content item. The user devices 202a, 202b, 202c, 202d may receive status information and may use the status information to access additional information via other devices (e.g., service provider device). The status information may include a portion of the content being displayed such as a screen shot so that the recipient devices may present a graphical representation of the content being presented on various devices. Additionally or alternatively, the status information may comprise information associated with a user interface (UI) being displayed at the respective user devices 202a, 202b, 202c, 202d. For example, information indicating a UI identifier, UI graphics position, cursor position, selected menu items, and the like.

The communication of status information between various devices may facilitate the switching between content being presented via various devices. As an example, if a user wants to tune a living room device to the program currently being watched on an office device, the user may request a “last known” position from the office device. In particular, the living room device may access a registry of devices including the status information received from the office device. This status information may be used to tune the living room device to the most up-to-date position in content being presented via the office device. As another example, the living room device may make an in-time request to the office device to update the status information associated with the office device. A response to the request may include up-to-date content information including a content identifier associated with a content item and a playback position in the content item. The response may include a current action being taking on the office device (e.g., playback is at position 2:20 and content is paused or playback is at position 1:44 and content is rewinding at 3× rewind). Other configurations may be used and other information may be shared. Additionally or alternatively, one or more devices may configure a user interface based on the status information associated with another device.

Once a tuning operation is complete, one or more of the tuned devices may receive an input, such as an audio input via a microphone. This input may be representative of the content (audio) currently being provided via the tuned device. As an example, two devices may be configured to receive an audio feedback of the output audio of the respective device. The audio feedback of each device may be compared to determine if both devices are outputting at least the same audio. Thresholds of variability and timing may be set to determine whether the audio output of each of the devices is synchronized or unsynchronized. If audio is out of synchronization, an automated operation may adjust the audio, for example a volume, so that the user does not experience competing audio feeds from two different devices.

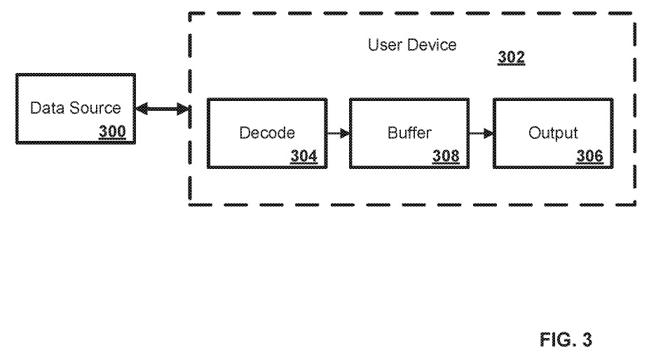

FIG. 3 shows an exemplary environment. Those skilled in the art will appreciate that present methods may be used in various types of networks and systems that employ both digital and analog equipment. One skilled in the art will appreciate that provided herein is a functional description and that the respective functions may be performed by software, hardware, or a combination of software and hardware.

One or more data sources 300 may be in communication with one or more user devices 302 for accessing, storing, and/or transmitting data, e.g., a transmission of file-based content. One or more of the sources 300 may be or comprise a large area (wide area), such as a national programming source, or a small area (local area) such as a local programming source (e.g., local affiliate). One or more of the sources 300 may be or comprise content delivery networks (CDN). One or more of the sources 300 may be or comprise a content provider (e.g., provider of audio content, video content, data services, news and programming, advertisements, alternate content, etc.) configured to transmit the data (e.g., as content assets via a stream, fragments, files, etc.) to various end-users.

One or more of the sources 300 may be or comprise a supplemental content database. The supplemental content database can comprise an advertisement or alternate content database (e.g., second screen content) having a plurality of advertisements stored therein or capable of accessing advertisements stored elsewhere. As an example, the advertisement database can comprise a plurality of video advertisements, which can be interactive or other types of advertisements. As a further example, the plurality of video advertisements can each have a particular time duration associated therewith. The time duration associated with the advertisements, alternate, and/or supplemental content can be varied in duration. As an example, a particular advertisement can have multiple versions, wherein each version of the same advertisement can have a different time duration. Accordingly, an advertisement having a particular time duration can be retrieved to fill a time slot having a substantially equal time duration.

The user device 302 may be an electronic device such as a computer, a smartphone, a laptop, a tablet, a set top box, a display device, or other device capable of communicating with the data source 300. The user device 302 may be or comprise a set-top box, an over-the-top device, a network-enabled device, a mobile device, etc.

The user device 302 may comprise a decoder 304 configured to receive an encoded content item and to decode the content item to facilitate presentation via an output 306. The user device 302 may comprise a buffer 308 (e.g., local storage). As an example, one or more content items or portion of content items may be buffered via the buffer 308 to provide a stream of decoded content for presentation via the output 306. One or more of the user devices 302 may be the same or similar to user device 102 (FIG. 1). Two or more of the user devices 302 may be configured to synchronize content being presented via the respective ones of the user devices 302.

Methods may facilitate the synchronization (e.g., alignment of timing of playback) of content across multiple devices such as the user devices 302, for example. As an example, content may be provided to the multiple devices by the same or parallel sources (e.g., IP, QAM). As a further example, the multiple displays may be configured to present the same content (e.g., a hockey game at a bar, a booth or conference with multiple displays of the same content, etc.). However, the methods may be applicable in other configurations and may be applied across multiple network types (e.g., MoCA, WiFi) or a combination of network types, for example, through the use of a bridging device, such as a MoCA enabled WiFi gateway.

One method may comprise designating or receiving a designation of as a reference (or master) device. This reference device may be manually designated, for example, or may be dynamically selected as the reference device for a user account, premises, or location. Other devices may be designated as subscribers of the reference device. The subscriber devices may be a heterogeneous mix of devices that are capable of displaying the same content as the reference device. The subscriber devices may have different capabilities and properties or may be the same. The subscriber devices may have form of time alignment, for example, time-aligned via NTP or similar mechanism that provides synchronized clocks.

In an example operation, the reference device may access or receive a content item, decode it, and transmit the decoded content item it to an output for presentation. The reference device may buffer at least a portion of the content item. The subscriber devices may interrogate the reference device for a current playback position. The reference device may respond with status information comprising a current or predicative playback position (e.g., a frame it will be presenting in ‘n’ seconds).

As an example, the status information may include a predictive playback position to account for network latency and/or to ensure the receipt of the status information by a subscriber device before the frame is actually played back via the reference device.

As another example, the reference device may spend 33.3ms presenting each frame. As such, the status information indicating a frame does not necessarily reflect whether the frame has just started or whether the reference device is in the middle of processing the frame. As such, an error in synchronization may be 33.3 ms plus any inaccuracy in the clock, buffer, and other factors. Accordingly, instead of the status information indicating that “in 2 seconds the reference device will be processing frame 100,” the status information may indicate that “in 2 seconds the reference device will start playback from frame 100.”

As another example, the status information may include a predictive playback position to account for an output buffer of the reference device. If an output buffer includes ‘x’ milliseconds of content, the status information may indicate playback of a particular frame in at least ‘x’ milliseconds. Similar, the subscriber devices may account for their own output buffer to better match the playback position of the reference device. One or more of the reference device and the subscriber devices may adjust a playback position and/or a playback rate/speed. For example, if a subscriber device determines the playback position is one second off of the reference device, one or both of the subscriber device and the reference device may be caused to speed up or slow down it's playback to address the discrepancy. The subscribed devices will receive the information and can predict their frame location at the synchronized time and calculate the difference. Alternatively, they can calculate when they will reach the reference frame from the master device and calculate the difference that way.

Decoding the content, buffing, and transmission to the output (e.g., HDMI) may comprise process information such as a time of processing or latency across device. Additional adjustments can be made if the discrepancy between devices can be captured on the output side, as well, using the same methods described above. Such methods may be used to determine a discrepancy in timing between devices, such as to delay by some value one device from another. For example, such determination may be used to account for audio lag over distances, to provide a buffer between devices, and/or to apply censoring or other effects.

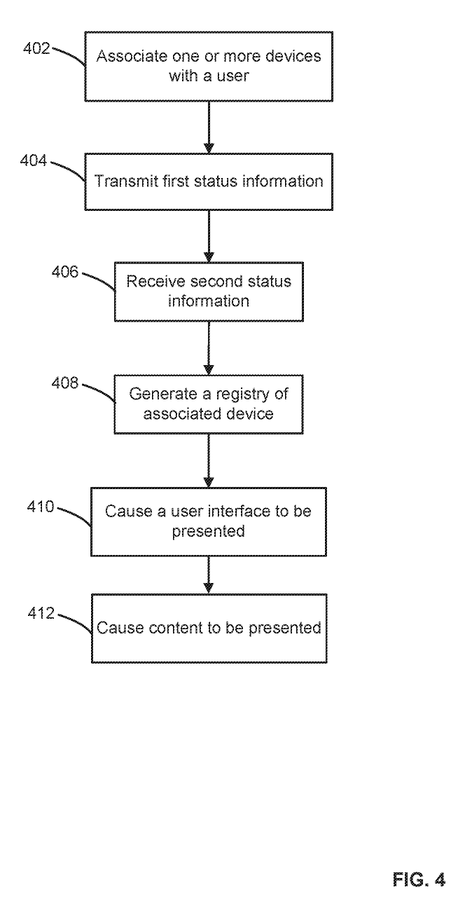

FIG. 4 shows an example method for the discovery and/or synchronization of one or more devices. In step 402, one or more devices may be associated with a user (e.g., user account). As an example, a first device and a second device may be associated with a user account. One or more of the first device and the second device may be or comprise a set-top box, an over-the-top device, an Internet-capable television, or a mobile device.

In step 404, first status information may be transmitted (e.g., broadcast). The first status information may be transmitted via a premises network such as a MoCA network or a WLAN, or both, for example. The first status information may be associated with the first device. The first status information may be or comprise a first device identifier, a first content identifier, and a first time code associated with the first content identifier. The first content identifier may comprise a program identifier associated with a program guide. The first time code may indicate a position in a content item or predictive position in a content item.

In step 406, second status information may be received. The second status information may be received via the premises network. The second status information may be associated with the second device. The second status information may be or comprise a second device identifier, a second content identifier, and a second time code associated with the first content identifier. The second content identifier may comprise a program identifier associated with a program guide. The second time code may indicate a position in a content item or predictive position in a content item.

In step 408, a registry of associated devices may be generated based at least on the first status information and the second status information. The registry may identify the transmitting device and the content item being presented via the transmitting device. When a device transmits updated status information, the receiving devices may receive the status information and may update the registry of devices. If a device has not reported in for pre-defined time period, status information associated with the device may be removes from the registry of devices or a direct interrogation/request may be made of the device (or other device or system) for updated status information. One or more of the first status information and the second status information may include a time to live element such that expiration of the time to live element causes the respective one or more of the first status information and the second status information to be removed from the registry of associated devices.

In step 410, a user interface may be caused to be presented based at least on the registry of associated devices. The user interface may facilitate navigation between content provided via one or more devices associated with the user account. The user interface may be or comprise an indication of the content provided via the one or more devices associated with the user account. The user interface may be the same or similar to a user interface displayed on another device and may be selected or generated based at least on the first status information and/or the second status information.

In step 412, content may be presented via the first device. As an example, the content outputted (e.g., rendered, played back, etc.) via the first device may be synchronized with content rendered via the second device based at least on the registry of associated devices. Synchronization of content may comprise presenting content on two or more device such that display of the content is within a threshold time or frame. The threshold may be predetermined and may be modified.

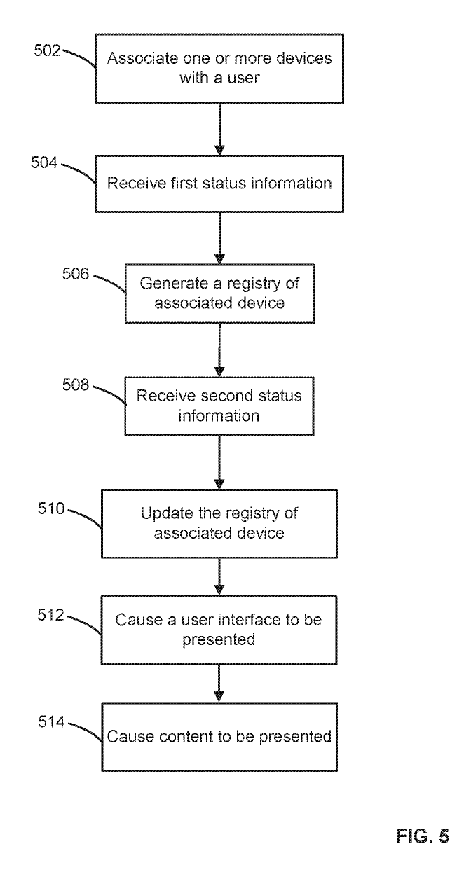

FIG. 5 shows an example method for the discovery and/or synchronization of one or more devices. In step 502, one or more devices may be associated with a user (e.g., user account). As an example, a first device and a second device may be associated with a user account. One or more of the first device and the second device may be or comprise a set-top box, an over-the-top device, an Internet-capable television, or a mobile device.

In step 504, first status information may be received. The first status information may be received via a premises network such as a MoCA network or a WLAN, or both, for example. The first status information may be associated with the first device. The first status information may be or comprise a first device identifier, a first content identifier, and a first time code associated with the first content identifier. The first content identifier may comprise a program identifier associated with a program guide. The first time code may indicate a position in a content item or predictive position in a content item.

In step 506, a registry of associated devices may be generated based at least on the first status information. The registry may identify the transmitting device and the content item being presented via the transmitting device. The first status information may include a time to live element such that expiration of the time to live element causes the first status information to be removed from the registry of associated devices.

In step 508, second status information may be received. The second status information may be received via the premises network. The second status information may be associated with the first device. The second status information may be or comprise a second device identifier, a second content identifier, and a second time code associated with the first content identifier. The second content identifier may comprise a program identifier associated with a program guide. The second time code may indicate a position in a content item or predictive position in a content item.

In step 510, the registry of associated devices may be updated based at least on the second status information. As an example, when a device transmits updated status information, the receiving devices may receive the status information and may update the registry of devices. If a device has not reported in for pre-defined time period, status information associated with the device may be removes from the registry of devices or a direct interrogation/request may be made of the device (or other device or system) for updated status information.

In step 512, a user interface may be caused to be presented based at least on the registry of associated devices. The user interface may facilitate navigation between content provided via one or more devices associated with the user account. The user interface may be or comprise an indication of the content provided via the one or more devices associated with the user account. The user interface may be the same or similar to a user interface displayed on another device and may be selected or generated based at least on the first status information and/or the second status information.

In step 514, content may be presented via the first device. As an example, the content rendered via the first device is synchronized with content rendered via the second device based at least on the registry of associated devices.

If a device (e.g., first device) determines that its playback of content is ahead of a reference device or content, the device may slow playback so that it will be at the same reference frame as the reference device at the same time. The device may accomplish such a reduction in playback by adding imperceptible delay to the output side of the video processing unit (slowing each frame by a few milliseconds, for example). Since the decode process itself is not being delayed, the frames being decoded may be buffered.

If a device (e.g., first device) determines that its playback of content is behind a reference device or content, the device may speed up playback so that it will be at the same reference frame as the reference device at the same time. The device may accomplish this increase in playback by dropping frames on an output side to “catch up,” pulling content from a buffer until frames are synchronized.

Systems and methods may be configured to ensure that there is adequate buffer across all devices in the system (e.g., introducing a 5 second startup buffer) for the devices to adjust their timing in either direction to compensate for their playback drift. Devices may be configured to notify each other or a master/reference device in order to allow the entire network of devices to better align itself and smooth out the playback drift, for example, by allowing devices to make their own adjustments based on other devices in the system.

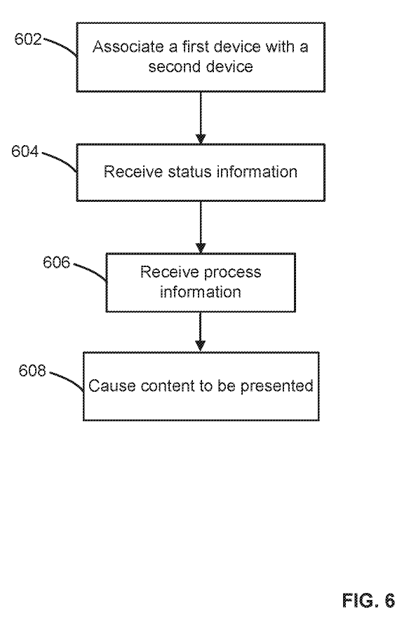

FIG. 6 shows an example method for the discovery and/or synchronization of one or more devices. In step 602, one or more devices may be associated with a user (e.g., user account). As an example, a first device and a second device may be associated with a user account. One or more of the first device and the second device may be or comprise a set-top box, an over-the-top device, an Internet-capable television, or a mobile device.

In step 604, status information may be received. The status information may be received via a premises network such as a MoCA network or a WLAN, or both, for example. The status information may be associated with the second device. The status information may be or comprise a device identifier, a content identifier, and a time code associated with the content identifier. The content identifier may comprise a program identifier associated with a program guide. The time code may indicate a position in a content item or predictive position in a content item.

In step 606, process information may be received. The process information may be or comprise information associated with the time delay in processing content via a particular device, such as the first device.

In step 608, content may be presented via the first device. As an example, the content rendered via the first device is synchronized with content rendered via the second device. As an example, the content may presented as a group of picture-in-picture windows generated on the second device. Other presentations, menus, and display options may be used.

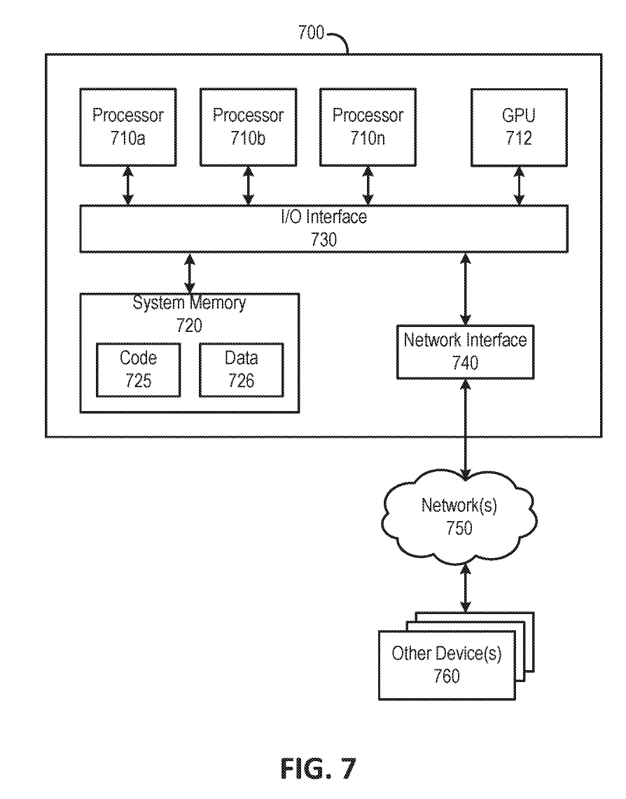

FIG. 7 depicts a general-purpose computer system that includes or is configured to access one or more computer-accessible media. A computing device 700 may include one or more processors 710a, 710b, and/or 710n (which may be referred herein singularly as the processor 710 or in the plural as the processors 710) coupled to a system memory 720 via an input/output (I/O) interface 730. The computing device 700 may further include a network interface 740 coupled to an I/O interface 730.

The computing device 700 may be a uniprocessor system including one processor 710 or a multiprocessor system including several processors 710 (e.g., two, four, eight, or another suitable number). The processors 710 may be any suitable processors capable of executing instructions. For example, the processor(s) 710 may be general-purpose or embedded processors implementing any of a variety of instruction set architectures (ISAs), such as the x86, PowerPC, SPARC, or MIPS ISAs, or any other suitable ISA. In multiprocessor systems, each of the processors 710 may commonly, but not necessarily, implement the same ISA.

A graphics processing unit (“GPU”) 712 may participate in providing graphics rendering and/or physics processing capabilities. A GPU may, for example, comprise a highly parallelized processor architecture specialized for graphical computations. The processors 710 and the GPU 712 may be implemented as one or more of the same type of device.

The system memory 720 may be configured to store instructions and data accessible by the processor(s) 710. The system memory 720 may be implemented using any suitable memory technology, such as static random access memory (“SRAM”), synchronous dynamic RAM (“SDRAM”), nonvolatile/Flash®-type memory, or any other type of memory. Program instructions and data implementing one or more desired functions, such as those methods, techniques and data described above, are shown stored within the system memory 720 as code 725 and data 726.

The I/O interface 730 may be configured to coordinate I/O traffic between the processor(s) 710, the system memory 720 and any peripherals in the device, including an network interface 740 or other peripheral interfaces. The I/O interface 730 may perform any necessary protocol, timing or other data transformations to convert data signals from one component (e.g., the system memory 720) into a format suitable for use by another component (e.g., the processor 710). The I/O interface 730 may include support for devices attached through various types of peripheral buses, such as a variant of the Peripheral Component Interconnect (PCI) bus standard or the Universal Serial Bus (USB) standard, for example. The function of the I/O interface 730 may be split into two or more separate components, such as a north bridge and a south bridge, for example. Some or all of the functionality of the I/O interface 730, such as an interface to the system memory 720, may be incorporated directly into the processor 710.

The network interface 740 may be configured to allow data to be exchanged between the computing device 700 and other device or devices 760 attached to a network or networks 750, such as other computer systems or devices, for example. The network interface 740 may support communication via any suitable wired or wireless general data networks, such as types of Ethernet networks, for example. Additionally, the network interface 740 may support communication via telecommunications/telephony networks, such as analog voice networks or digital fiber communications networks, via storage area networks, such as Fibre Channel SANs (storage area networks), or via any other suitable type of network and/or protocol.

The system memory 720 may be or comprise a computer-accessible medium configured to store program instructions and data as described above for implementing methods and apparatus. However, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device the 700 via the I/O interface 730. A non-transitory computer-accessible storage medium may also include any volatile or non-volatile media, such as RAM (e.g., SDRAM, DDR SDRAM, RDRAM, SRAM, etc.), ROM, etc., that may be included in the computing device 700 as the system memory 720 or another type of memory. Further, a computer-accessible medium may include transmission media or signals, such as electrical, electromagnetic or digital signals, conveyed via a communication medium, such as a network and/or a wireless link, such as those that may be implemented via the network interface 740. Portions or all of multiple computing devices, such as those illustrated in FIG. 7, may be used to implement the described functionality; for example, software components running on a variety of different devices and servers may collaborate to provide the functionality. Portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the present disclosure may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the assembly and electronic system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

The methods and systems may employ artificial intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It is to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and comprise the disclosed systems. These and other components are disclosed herein, and it is understood that when combinations, subsets, interactions, groups, etc. of these components are disclosed that while specific reference of each various individual and collective combination and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

It will be apparent to those skilled in the art that various modifications and variations may be made without departing from the scope or spirit. Other aspects will be apparent to those skilled in the art from consideration of the specification and practice disclosed herein. It is intended that the specification and examples be considered as exemplary only, with a true scope and spirit being indicated by the following claims.

What is claimed is:

1. A method comprising:
transmitting, by a first device and via a premises network, first status information indicative of first content outputted via the first device;
receiving, via the premises network, second status information associated with a second device, wherein the second status information is indicative of second content outputted via the second device;
generating, based at least on the first status information and the second status information, a registry of associated devices; and
causing, based at least on the registry of associated devices, output of a user interface comprising an indication of one or more of the first content and the second content, wherein the user interface is configured to receive a selection associated with the one or more of the first content and the second content and to cause output of the one or more of the first content and the second content based on the selection.

2. The method of claim 1, wherein the premises network comprises a local area Internet protocol (IP) network or a multimedia over coax alliance (MoCA) network.

3. The method of claim 1, wherein one or more of the first status information and the second status information comprises a time-to-live element such that expiration of the time-to-live element causes the respective one or more of the first status information and the second status information to be removed from the registry of associated devices.

4. The method of claim 1, wherein one or more of the first status information and the second status information comprises a program identifier associated with a program guide.

5. The method of claim 1, wherein the first status information comprises a first device identifier, a first content identifier, and a first time code associated with the first content identifier, and wherein the second status information comprises a second device identifier, a second content identifier, and a second time code associated with the second content identifier.

6. The method of claim 5, wherein one or more of the first time code and the second time code indicates a position in a content item or predictive position in a content item.

7. The method of claim 1, wherein the second device is disposed internal to a premises associated with the premises network.

8. The method of claim 1, wherein the second device is disposed external to a premises associated with the premises network.

9. A method comprising:
receiving, via a premises network, first status information indicative of first content outputted via a first device;
generating a registry of associated devices based at least on the first status information;
receiving, via the premises network, second status information associated with a second device, the second status information indicative of second content outputted via the second device;
updating the registry of associated devices based at least on the second status information; and
causing, based at least on the registry of associated devices, output of a user interface comprising an indication of one or more of the first content and the second content, wherein the user interface is configured to receive a selection associated with the one or more of the first content and the second content and to cause output of the one or more of the first content and the second content based on the selection.

10. The method of claim 9, wherein the receiving the first status information comprises receiving a broadcast transmission from the second device.

11. The method of claim 9, wherein the receiving the second status information comprises one or more of receiving a broadcast transmission from the second device and receiving a transmission from a device to which the first device has subscribed.

12. The method of claim 9, wherein one or more of the first status information and the second status information comprises a time-to-live element such that expiration of the time-to-live element causes the respective one or more of the first status information and the second status information to be removed from the registry of associated devices.

13. The method of claim 9, wherein one or more of the first status information and the second status information comprises a program identifier associated with a program guide.

14. The method of claim 9, wherein the first status information comprises a first device identifier, a first content identifier, and a first time code associated with the first content identifier, and wherein the second status information comprises a second device identifier, a second content identifier, and a second time code associated with the second content identifier.

15. The method of claim 14, wherein one or more of the first time code and the second time code indicates a position in a content item or predictive position in a content item.

16. The method of claim 9, wherein the second device is disposed internal to a premises associated with the premises network.

17. The method of claim 9, wherein the second device is disposed external to a premises associated with the premises network.

18. A method comprising:
associating a first device with a second device such that status information transmitted by the second device is accessible by the first device;
receiving status information associated with the second device, wherein the second status information is indicative of first content outputted via the second device, and wherein the status information comprises a device identifier associated with the second device, a content identifier associated with the first content, and a predictive content position associated with the content identifier; and
causing second content to be outputted via the first device, wherein the second content outputted via the first device is synchronized with the first content outputted via the second device based at least on the status information.

19. The method of claim 18, further comprising receiving process time information associated with the first device, wherein the second content outputted via the first device is synchronized with the first content outputted via the second device based at least on the process time information.

20. The method of claim 18, wherein the second content outputted via the first device is synchronized with the first content outputted via the second device by adjusting a playback rate of the first device or adjusting a playback position of the second content outputted via the first device, or both.
